(19) United States
(12) Patent Application Publication
(10) Pub. No.: US 2020/0300808 A1
(43) Pub. Date: Sep. 24, 2020

(54) POTENTIOMETRIC SENSOR

(71) Applicant: Endress+Hauser Conducta GmbH+Co. KG, Gerlingen (DE)

(72) Inventors: Torsten Pechstein, Radebeul (DE); Manfred Jagiella, Notzingen (DE)

(21) Appl. No.: 16/899,012

(22) Filed: Jun. 11, 2020

Related U.S. Application Data
(62) Division of application No. 15/373,395, filed on Dec. 8, 2016.

(30) Foreign Application Priority Data
Dec. 8, 2015 (DE) 10 2015 121 364.8

(51) Int. Cl. G01N 27/416; G01N 27/333

(52) U.S. Cl. CPC G01N 27/4167; G01N 27/333

(57) ABSTRACT

A potentiometric sensor includes an electrochemical half-cell with an inner electrolyte, a pickup electrode contacting the inner electrolyte, a sensor element that, in order to detect measured values, can be brought into contact with a measuring medium and, especially, is immersible in the measuring medium, where the sensor is designed as a composite body that includes an ion-selective component which is in contact with the inner electrolyte.

### CROSS-REFERENCE TO RELATED APPLICATIONS

The present divisional application is related to and claims the priority benefit of U.S. patent application Ser. No. 15/373,395, filed on Dec. 8, 2016, and of German Patent Application No. 10 2015 121 364.8, filed on Dec. 8, 2015, the entire contents of which are incorporated herein by reference.

### TECHNICAL FIELD

The present disclosure relates to a potentiometric sensor. The sensor can, for example, be used to measure a measured variable which depends upon the activity of an analyte in a measuring medium. This measured variable can, for example, be an activity or a concentration of the analyte, such as a specific ion species or a pH value. The measuring medium can be a measuring liquid such as an aqueous solution, emulsion, or suspension.

### BACKGROUND

Potentiometric sensors are used in the laboratory and process measurement technology in many areas of chemistry, biochemistry, pharmacy, biotechnology, food technology, water management, and environmental monitoring for the analysis of measuring media, especially, measuring fluids. Potentiometric sensors allow detection of activities of chemical substances, such as ion activities, and therewith correlated measured variables in liquids. The substance whose concentration or activity is to be measured is also referred to as the analyte.

Potentiometric sensors typically comprise a measuring half-cell and a reference half-cell, as well as a measurement circuit. In contact with the measuring medium, e.g., a measuring fluid, the measuring half-cell forms a potential that is a function of the activity of the analyte in the measuring medium, whereas the reference half-cell provides a stable reference potential independent of the analyte concentration. The measurement circuit generates an analog or digital measuring signal that represents the potential difference between the measuring half-cell and the reference half-cell. The measuring signal may be output from the measurement circuit to a higher-level unit which is connected to the sensor and further processes the measuring signal. The higher-level unit can be a measuring transducer or a process controller such as a PLC.

The reference half-cell of potentiometric sensors comprises a reference element which is in contact with a reference electrolyte. The reference electrolyte is housed in a chamber formed in a housing of the reference half-cell. The reference electrolyte must be in electrolytic contact with the measuring medium in order to perform a potentiometric measurement. This contact is established by an electrochemical junction, which may consist of, for instance, a through-hole that passes through the entire housing wall, a porous diaphragm, or a gap. The potential of the reference half-cell is defined by the reference electrolyte and the reference element. If the reference electrode is configured as, for example, a silver/silver chloride reference electrode, the reference electrolyte is an aqueous solution with a high chloride concentration, usually a 3-molar potassium chloride solution, while the reference element is a silver wire coated with silver chloride. The reference element is connected in an electrically-conductive manner to the aforementioned measuring circuit in order to detect the difference in potential between the reference and measuring half-cells.

The measuring half-cell includes a potential-forming sensor element which may comprise, for example, an ion-selective membrane, depending upon the nature of the potentiometric sensor. Examples of measuring half-cells with an ion-selective membrane are ion-selective electrodes (ISE). An ion-selective electrode has a housing that is sealed by the ion-selective membrane, which housing accommodates an inner electrolyte that is in contact with the membrane. Furthermore, the ion-selective electrode comprises a potential-sensing element which is in contact with the inner electrolyte. The potential-sensing element is connected in an electrically-conductive manner to the measurement circuit. If the measuring media is in contact with the ion-selective membrane for measuring, the membrane interacts selectively with a specific ion species in the measuring medium, i.e., the ion to be selectively detected with ISE. Changing the activity or concentration of the ion in the measuring medium to be detected by the ion-selective electrode causes a relative change in the equilibrium galvanic voltage between the measuring medium and the potential-sensing element in contact with the ion-selective membrane via the inner electrolyte. A special case of such an ion-selective electrode, i.e., an electrode that selectively detects the H⁺ or hydronium ion activity in a measuring liquid, is the known pH glass electrode, which comprises a glass membrane as the sensor element. Ion-selective electrodes are described in, for example, “Working with ion-selective electrodes,” K. Cammann, H. Galster, Springer, 1996.

The difference in potential between the potential-sensing element of the measuring half-cell and the reference element of the reference half-cell detectable by the measuring circuit is a measure of the measured variable dependent upon the activity of the analyte. The measuring circuit is designed to detect and possibly amplify the difference in potential between the potential-sensing element and the reference element, convert the difference into a digital signal, and output it as a measuring signal.

The sensor element of conventional potentiometric sensors is generally designed in the form of a stable, self-supporting structure such as, in the case of a pH glass electrode, a self-supporting glass membrane, or, in the case of an ion-selective electrode, a polymer membrane comprising an ionophore and conducting salts. The sensor element must satisfy a series of functions and properties. As its sensory function, it must have sufficient sensitivity and selectivity for the analyte. A sufficiently low impedance of the sensor element, in order to minimize the measuring error, is also desirable. To enable efficient production of the sensor, the sensor element should also be suitable for being connected to a sensor housing by the simplest possible means, or for being mounted liquid-tight in a socket formed in the wall of the sensor housing. If the sensor element is a pH-sensitive glass membrane that is fused to a tubular glass shaft, its thermal expansion coefficient should, for example, be adjusted to that of the glass shaft. The melting temperatures should also be adjusted to each other in this case. Furthermore, safety-related aspects can play a role. In certain applications, the sensor element must not release any poisonous substances and/or must be biocompatible. Additional considerations such as sterilizability, availability of materials, or production costs can play a role.

The selection and composition of a sensor element is frequently a compromise between these required properties and functions. Accordingly, pH glass membranes are, on the one hand, highly selective; however, they are generally provided with a wall thickness of a few tenths of a millimeter, to achieve an acceptable sensor impedance of <1 GΩ. The membranes are, therefore, highly sensitive to breakage.

For the potentiometric measurement of pH, enamel electrodes, ISFET half-cells, or metal oxide pH half-cells are alternatives to pH glass electrodes.

Enamel electrodes have a pH-sensitive element consisting of enamel, the potential of which is discharged with a fixed lead, i.e., the electrically-conductive potential-sensing element is directly, without inner electrolyte, in contact with the enamel. Such enamel electrodes have poorer sensory properties than pH glass electrodes. Furthermore, their high sensitivity to polarization and higher production costs in comparison to pH glass electrodes are disadvantageous.

ISFET half-cells are mechanically robust. For measuring pH, ISFET half-cells are available in the prior art that possess greater selectivity than pH glass membranes. On the other hand, ISFET cells are more expensive and less chemically resistant than pH glass electrodes.

Metal oxide pH half-cells generally manifest significant leakage current during measurement, and their sensory properties, especially their selectivity, are therefore much worse than those of a pH glass electrode or an ISFET half-cell.

### SUMMARY

It is, accordingly, the object of the present disclosure to present a potentiometric sensor that overcomes the disadvantages described here.

The potentiometric sensor according to the present disclosure comprises an electrochemical half-cell with: an inner electrolyte, a pickup electrode contacting the inner electrolyte, and a sensor element that, in order to detect measured values, can be brought into contact with a measuring medium and is immersible in the measuring medium, wherein the sensor is designed as a composite body that comprises an ion-selective component which is in contact with the inner electrolyte.

By means of the potentiometric sensor, measured values of a measured variable can be detected that depend upon the activity of the ion species in the measuring medium, which can be a measuring liquid, with which the ion-selective component in contact with the medium interacts selectively. In addition to the ion activity itself, such measured variables can be the ion concentration or measured variables dependent upon the ion concentration or activity. An example of such a measured variable is the pH that corresponds to the negative decadic logarithm of the activity of hydronium ions, also termed oxonium ions, in an aqueous solution. Non-ionic species can also be detected by indirect determination, by letting them participate in a suitable chemical reaction in which ions are generated or consumed.

The composite body serves as a sensor element of the potentiometric sensor. It can be formed from the ion-selective component and at least one additional component.

Since the sensor element of the potentiometric sensor is designed as a composite body that can comprise one or more additional components beyond the ion-selective component, the sensor element can be optimized to a plurality of different desirable properties. This can be accomplished by suitably combining the additional component or additional components of the composite body with the ion-selective component. Accordingly, for example, an ion-selective component that has a high selectivity, but possesses unfavorable mechanical properties by itself, such as a weak break resistance or poor processability, can be combined with other components which lend the overall composite body greater stability, break resistance, or improved processability. The composite body is preferably designed to be heterogeneous, such that the ion-selective component and additional components are designed as volume elements of the composite body which contact each other via common interfaces, such as in the form of a stack of layers, wherein each layer forms a component of the composite body.

The ion-selective component can be formed from an ion-selective material such as pH membrane glass, an ion-conductive metal salt (such as LaF₃ as a fluoride-selective component), a liquid non-miscible with water that comprises an ionophore as a selectivity-promoting component, or a matrix material such as a polymer material in which is contained an ionophore as a selectivity-promoting component, possibly together with a conductive salt.

In one embodiment, the ion-selective component is an ion-selective glass, especially a pH membrane glass, wherein the thermal expansion coefficients of the ion-selective component and all other components of the composite body are adjusted to each other, and preferably differ from each other by less than 10%. This ensures that the composite body remains stable even when it is exposed to temperature fluctuations during measurement.

As an additional component, the composite body can have a substrate comprising a solid body, on which the ion-selective component is arranged as a coating. Alternatively or additionally, the ion-selective component can have penetrated the pores of the substrate. This embodiment is advantageous when, for example, the ion-selective component is an ion-selective glass such as pH glass. The substrate can mechanically stabilize the ion-selective glass so that the danger of breakage is significantly less than with a conventional pH glass membrane.

The coating can cover an exterior side of the substrate that faces the measuring medium during measurement and/or have penetrated the outwardly-facing pores of the substrate, and be intended to contact the measuring medium. The coating can cover both the exterior side as well as an opposing interior side of the substrate which faces away from the measuring medium during measurement, and/or can have penetrated outwardly-facing and inwardly-facing pores of the substrate so that the coating contacts the inner electrolyte and can also be brought into contact with the measuring medium. In this embodiment, there is an electrically-conductive connection by means of electron and/or ion conduction between the coating covering the exterior side of the substrate and the coating covering the interior side of the substrate in contact with the inner electrolyte. Such a conductive connection can be produced by the substrate having electrical conductivity. This electrical contact can, for example, be ensured by an electron conductivity and/or an ion conductivity of the substrate. Another possibility is for the substrate to have pores, or large cavities and/or channels, which are at least partially filled with the ion-selective component, so that the coating on the exterior side and the coating on the interior side of the substrate can come into contact with each other by means of a continuous connection through the ion-selective component via the pores, cavities, and/or channels.

The substrate can comprise a liquid-permeable, especially porous, solid body. The pores can be filled at least partially with the liquid inner electrolyte. An ion-selective component, arranged on at least the exterior side of the substrate as a coating that faces the measuring medium during sensor operation, can thereby be in contact at the rear with the inner electrolyte via the electrolyte-filled pores.

The substrate can comprise a porous ceramic, a porous glass, a porous metal, a metal sieve, or a metal fabric.

The substrate can alternatively comprise a glass, especially a core membrane glass, that has a specific impedance of 1 GΩmm² mm⁻¹ to 10⁴ GΩmm² mm⁻¹ at 25° C. The core membrane glass has a greater conductivity than a typical pH-sensitive glass membrane or a typical ion-selective membrane. pH glass membranes typically have a specific impedance of 1 GΩmm² mm⁻¹ to 10⁵ GΩmm² mm⁻¹ at 25° C. The use of a composite body consisting of the ion-selective component and the substrate comprising a glass as a sensor element can accordingly serve to provide reduced impedance of the sensor element, with improved mechanical stability.

In both of the aforementioned embodiments, the ion-selective component can be designed as a coating of the substrate or as a membrane applied to the substrate. For example, the ion-selective component can be a pH glass coating applied to its exterior side facing the measuring medium, or a pH glass membrane lying on the exterior side of the substrate. Alternatively, the ion-selective component can be designed as an ion-selective membrane covering the substrate on its exterior side, such as a polymer membrane that comprises an ionophore and at least one conductive salt.

The composite body can have a rod or disk shape. On the one hand, this is useful for integrating the composite body in the wall of a sensor housing such that the exterior side of the composite body can be exposed to a measuring medium, whereas an opposing side facing the interior of the housing can be in contact with the inner electrolyte. On the other hand, this ensures that the surface which can be exposed to the measuring media is planar, i.e., flat. In comparison to, for example, conventional glass electrodes with a glass membrane that is dome-shaped for production reasons, this yields greater mechanical stability for the sensitive surface and makes it possible to also perform measurements with the sensor in small volumes of measuring liquid.

In one embodiment, the composite body can be designed as a composite membrane.

In one embodiment of the potentiometric sensor, the half-cell comprises a half-cell housing in which a half-cell chamber is formed, wherein the inner electrolyte is accommodated in the half-cell chamber, wherein at least one section of the pickup electrode is arranged in the half-cell chamber, and wherein the composite body seals the half-cell chamber on one side.

The composite body can be materially bonded to the half-cell housing by, for example, adhesion or fusion.

In this embodiment, the composite body can comprise a ceramic substrate that is integrally bonded to a housing wall consisting of the same ceramic, wherein the ion-selective component is designed as a coating applied to an exterior side of the substrate consisting of, for example, pH-sensitive glass or another ion-selective substance. It is also possible for the composite body to be connected to the half-cell housing by means of a liquid-tight socket.

In an embodiment, the inner electrolyte can contact the ion-selective component of the composite body on the side of the composite body facing the half-cell chamber. In this embodiment, the composite body can comprise a porous substrate consisting of, for example, a porous ceramic, wherein the ion-selective component is designed as a coating applied to an exterior side of the substrate consisting of, for example, pH-sensitive glass or another ion-selective substance. The pores of the substrate can be at least partially filled with an inner electrolyte that contacts the coating at the rear. In this embodiment, the pickup electrode can run at least sectionally within the substrate, so that it is in contact with the inner electrode absorbed in the pores. In an extreme case, a region of the substrate facing away from the side of the substrate provided with the ion-selective coating can be free of inner electrolyte, such that all the inner electrolyte of the half-cell lies within the substrate. This is a very space-saving embodiment that can be used for miniaturized potentiometric sensors.

In another embodiment, the composite body can be fused into a wall of the half-cell housing or mechanically affixed in the wall via a sealing element by means of a fixation device that can be connected with the wall and again be detached.

In addition to the aforementioned half-cell that serves as a measuring half-cell, the potentiometric sensor can further comprise a reference half-cell that has: a reference half-cell chamber, a reference electrolyte contained within the reference half-cell chamber, a reference electrode that is arranged at least sectionally within the reference half-cell chamber and contacts the reference electrolyte, and has an electrochemical junction arranged in the wall surrounding the reference half-cell chamber, by means of which the reference electrolyte contacts a medium located outside of the wall, especially the measuring medium.

Furthermore, the potentiometric sensor can comprise a measuring circuit that is connected to the pickup electrode and reference electrode and is designed to detect a difference in potential between the pickup electrode and reference electrode and output a measuring signal dependent thereon. The reference half-cell is designed to provide a stable reference potential that is independent of the composition of the measuring liquid, especially the ion activity. The measuring signal of the measuring circuit accordingly represents the measured variable dependent upon the activity of the ion species to be detected in a measuring medium contacting the electrochemical junction and the ion-selective component. The reference half-cell can comprise an electrode of the second kind, such as an Ag/AgCl reference electrode.

According to the present disclosure, a potentiometric sensor can be produced according to one or more of the above-described embodiments by means of a method comprising the following steps: producing a composite body comprising an ion-selective component; bringing the ion-selective component into contact with an inner electrolyte; contacting the inner electrolyte with an electrically-conductive pickup electrode.

In order to bring the ion-selective component into contact with the inner electrolyte, the following steps can be carried out in a first version of the method: connecting a wall of a measuring half-cell housing to the composite body, such that a measuring half-cell housing is formed that is sealed by the composite body; filling the measuring half-cell chamber with the inner electrolyte, such that the ion-selective component of the composite body is brought into contact with the inner electrolyte.

In another step, at least one section of the electrically-conductive pickup electrode can be introduced into the measuring half-cell chamber.

The production of the composite body can comprise: applying an ion-selective material, especially an ion-selective glass, such as a pH membrane glass, an ion-conductive metal salt or liquid comprising an ionophore, or a polymer matrix comprising an ionophore, to a solid-state substrate that is porous or comprises a core membrane glass.

In another step, the composite body produced in this manner that comprises the substrate and an ion-selective component formed from the ion-selective material can be connected to a shaft-shaped housing, especially a hollow cylindrical housing, to form the measuring half-cell housing enclosing the measuring half-cell chamber. For this purpose, the composite body can be fused into the housing, or connected to the housing by means of a socket that, for example, can comprise a screwed or clamp connection, etc., wherein the composite body can be sealed against the shaft and/or against the socket by means of a seal.

In a second method version alternative to the first method version, a solid body that comprises a porous solid body or core membrane glass can be initially connected in a first step to a hollow cylindrical shaft to form the measuring half-cell housing enclosing the measuring half-cell chamber, and then, in a second step, in order to create the composite body, an ion-selective material, especially an ion-selective glass such as a pH membrane glass, an ion-conductive metal salt or a liquid comprising an ionophore, or a polymer matrix comprising an ionophore, can be applied to the side of the solid body that faces outward and is connected to the shaft. The solid body also serves as a substrate for the ion-selective component formed from the ion-selective material.

In both versions of the method, the application of the ion-selective material can comprise immersion in a melt of an ion-selective glass or pH membrane glass, the melting of an ion-selective or pH-membrane glass, or a thick-layer or a thin-layer method for applying a coating of an ion-selective material to the substrate.

In both embodiments, the substrate formed from, for example, a ceramic can initially not have any pores, and can be provided with pores before or after the application of the ion-selective material.

### BRIEF DESCRIPTION OF THE DRAWINGS

The present disclosure is explained in further detail below on the basis of the embodiments shown in the illustrations. The figures show:

FIG. 1 shows a first exemplary embodiment of a potentiometric sensor for measuring pH;

FIG. 2 shows a measuring half-cell of a potentiometric sensor according to a second exemplary embodiment;

FIG. 3 shows a measuring half-cell of a potentiometric sensor according to a third exemplary embodiment;

FIG. 4 shows a measuring half-cell of a potentiometric sensor according to a fourth exemplary embodiment;

FIG. 5 shows a composite body with a pH-sensitive component.

### DETAILED DESCRIPTION

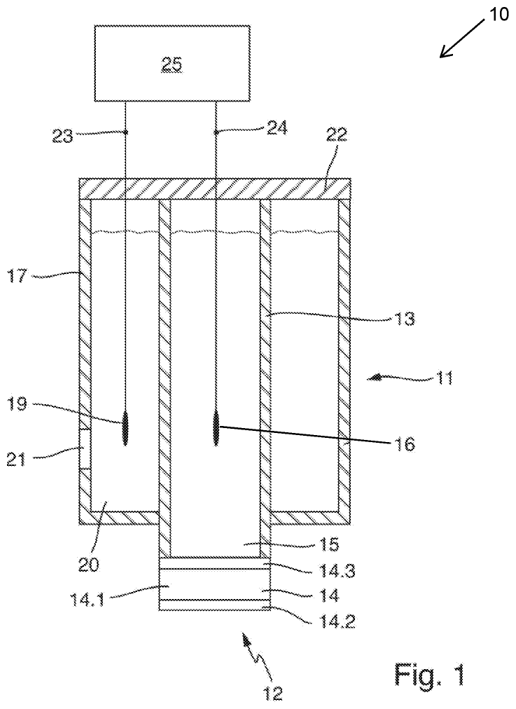

FIG. 1 shows a schematic representation of a pH sensor designed as a potentiometric combination electrode 10 that comprises a measuring half-cell 12 and a reference half-cell 11. The measuring half-cell 12 is accommodated in a tubular half-cell housing 13 consisting of an insulating material such as glass or plastic that is closed at one end by means of a pH-sensitive sensor element 14. A pH buffer solution, as the inner electrolyte 15 contacting the pH-sensitive sensor element 14, is accommodated in the half-cell housing 13, in which pH buffer solution an electrically-conductive potential-sensing element 16 is immersed. In the present example, the potential-sensing element 16 is designed as a chlorided silver wire.

The reference half-cell 11 is arranged concentrically around the measuring half-cell 12. It comprises a reference half-cell housing formed by an external, tubular housing part 17, consisting of an insulating material, and the outside of the measuring half-cell housing 13. At its end facing the sensor element 14, the housing part 17 is connected in a liquid-tight manner, such as by fusing, to the measuring half-cell housing 13 of the measuring electrode 12. A reference electrolyte 20 in which the reference element 19 is immersed is accommodated in the annular reference half-cell chamber formed in this manner. The reference element 19 can be formed from a chlorided silver wire, as is the potential-sensing element 16. The reference electrolyte 20 in the present example is a saturated potassium chloride solution that is thickened with a polymer. An electrochemical junction 21 is arranged in the outer tubular housing part 17 designed, here, as a through-hole. To perform pH measurements, a front-end region of the combination electrode, which comprises the electrochemical junction 21 and the pH-sensitive sensor element 14, is brought into contact with a measuring liquid. The reference electrolyte 20 is in contact with the measuring liquid via the junction 21, such that material can be transported between the reference electrolyte 20 and the measuring liquid.

At its rear end opposite the pH-sensitive sensor element 14, the housing of the combined electrode is sealed by gluing 22. The reference element 19 and potential-sensing element 16 are each connected to a measuring circuit 25 via a contact point 23, 24 arranged outside of the housing. The measuring circuit 25 is designed to detect a difference in potential between the measuring half-cell 12 and the reference half-cell 11 and output a measuring signal that represents the difference in potential. The measuring circuit 25 can be connected to a higher-level unit, such as a measuring transducer, to which it outputs the measuring signal.

In the present example, the sensor element 14 is designed as a composite body. The composite body is designed as a compound glass membrane which is formed from three superimposed glass layers. The layers 14.1, 14.2, and 14.3 have different specific impedances. A middle layer 14.1 is formed from a core membrane glass that has a conductivity of 1 GΩ/mm² mm⁻¹ to 10⁴ GΩmm² mm⁻¹ at 25° C. A first layer 14.2 consisting of a pH-sensitive membrane glass is arranged on an exterior side of the middle layer 14.1 facing the measuring liquid. A second layer 14.3 consisting of the same pH-sensitive membrane glass is arranged on an interior side of the middle layer 14.1 facing the measuring half-cell chamber. The surface and the layer thickness of the individual layers are chosen so that the composite body has an impedance within a range of 1 MΩmm² mm⁻¹ to 10 GΩmm² mm⁻¹ at 25° C.

During measurement, a hydrated layer forms on the surface of the first layer 14.2 contacting the measuring medium. At the interface between the membrane glass and the water-containing measuring liquid, a dissociation occurs, during which the alkali ions of the glass are replaced by H⁺ ions from the measuring liquid, thus creating a variety of hydroxyl groups in the hydrated layer. A corresponding hydrated layer also forms on the surface of the second layer 14.3 contacting the inner electrolyte. Depending upon the pH value of the measuring medium, H⁺ ions diffuse either from the hydrated layer or into the hydrated layer. Since the inner electrolyte has a constant pH, a difference in potential that depends upon the pH of the measuring liquid arises between the side in contact with the measuring liquid and the side of the sensor element 14 in contact with the inner electrolyte. This difference in potential determines the measuring half-cell potential. Interface effects at the interfaces between the three layers 14.1, 14.2, 14.3 balance each other out and, therefore, do not influence the measuring signal.

The composite body formed from the layers 14.1, 14.2, 14.3 has a thermal expansion coefficient that is adapted to the expansion coefficient of the half-cell housing 13 and preferably differs by less than 10% from the expansion coefficient of the half-cell housing. In the present example, it is fused with the half-cell housing 13. Due to the high conductivity of the core membrane glass, the pH-sensitive element 14 designed as a composite body can be designed to be significantly thicker than a pH glass membrane of a conventional glass electrode that consists exclusively of the less conductive pH membrane glass. Given the same thickness, this would reach an impedance much greater than 1 GΩ and would produce significant measuring errors if conventional signal-processing electronics were used.

Alternatively to the example depicted here, the potentiometric sensor can be designed as a measuring chain with two half-cells that are disconnectable from each other, i.e., not mechanically connected securely to each other, instead of a combination electrode. The exemplary embodiments of measuring half-cells described below can also be designed as a component of a potentiometric sensor designed as a combination electrode, as well as single half-cells that can be connected to a separate reference half-cell to form a potentiometric sensor.

In the production of the sensor depicted in FIG. 1, the composite body formed from the layers 14.1, 14.2, 14.3 can be produced first, and then fused to the measuring half-cell housing 13. It is, alternatively, also possible to first only blow a membrane formed from the core membrane glass onto the tubular housing 13 and, after hardening, coat the membrane formed in this manner with the membrane glass, using, for example, physical or chemical layering techniques.

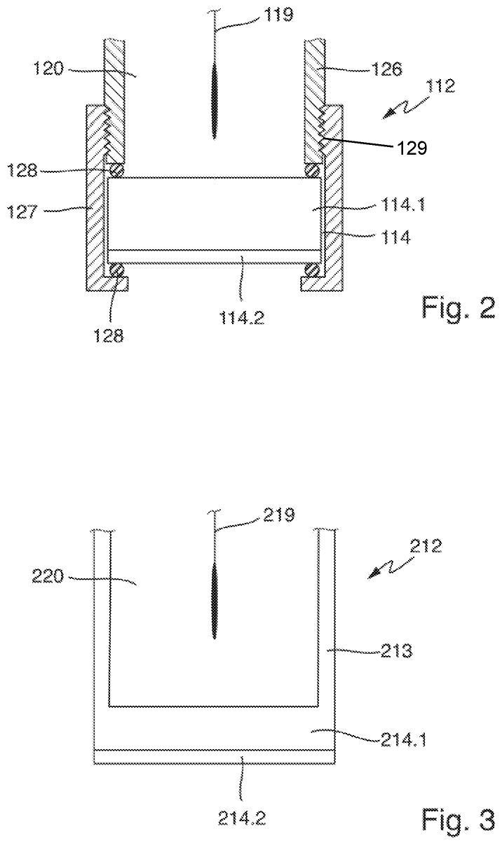

In a schematic representation, FIG. 2 shows an exemplary embodiment of a measuring half-cell 112 of a potentiometric sensor that can otherwise be designed similarly to the potentiometric sensor described with reference to FIG. 1. The measuring half-cell 112 comprises a disk-shaped, ion-selective sensor element 114 that is designed as a composite body consisting of a porous ceramic substrate 114.1 and an ion-selective coating 114.2 that is intended to contact the measuring fluid and is applied to the exterior side of the substrate 114.1. The coating 114.2 serves as an ion-selective component of the sensor element 114. The coating 114.2 can comprise an ion-selective polymer material or a pH membrane glass. The substrate 114.1 can be formed from a porous glass ceramic, the thermal expansion coefficient of which is adjusted to that of the coating 114.2. Suitable ceramic materials are, for example, zirconium dioxide or magnesium or yttrium-stabilized zirconium dioxide ceramic. The pH glass can be based upon a conventional pH silicate glass.

The ion-selective sensor element 114 is clamped in a measuring half-cell housing by elastomer sealing rings 128 and affixed in the wall of the housing such that the ion-selective coating 114.2 faces outward, and a side of the ion-selective sensor element 114 opposite the ion-selective coating 114.2 faces a half-cell chamber enclosed by the housing. A liquid inner electrolyte 120 is accommodated in the half-cell chamber and contacts the side of the ion-selective sensor element 114 facing the half-cell chamber. The liquid inner electrolyte 120 also fills the pores of the substrate 114.1 so that the ion-selective coating 114.2 is in contact at the rear with the inner electrolyte 120. Between the side of the coating 114.2 in contact with the measuring medium and the side of the coating 114.2 in contact with the electrolyte 120, a difference in potential accordingly forms that depends upon the ion concentration to be detected in the measuring liquid and determines the measuring half-cell potential. An electrically-conductive potential-sensing element 119 is immersed in the inner electrolyte 120 that (as described with reference to FIG. 1) is connectable to a measuring circuit of the potentiometric sensor which detects the difference in potential between the measuring half-cell and a reference half-cell.

The measuring half-cell housing in the present example is formed from a first tubular housing part 126 and a second tubular housing part 127. The annular housing part 127 is designed as a union nut and is connectable to the first housing part 126 by a threaded connection 129. Elastomer sealing rings 128 that are arranged above and below the ion-selective sensor element 114 and consist of an elastomer are pressed together by screwing the housing part 127 to the housing part 126, and the ion-selective sensor element 114 is accordingly affixed liquid-tight within the housing. A person skilled in the art is familiar with many other possibilities for clamping and/or affixing a disk-shaped element liquid-tight in a housing wall by elastomer seals. These can, of course, also be used for the purpose depicted here.

Advantageous in this exemplary embodiment is the high mechanical stability possessed by the ion-selective sensor element 114 designed as a composite body. This makes it possible to affix the ion-selective sensor element 114 under a certain mechanical load by being clamped liquid-tight between two elastomer seals in a housing wall. Since it is not materially bonded to the ion-selective sensor element 114, the housing can be produced from any non-electrically-conductive material, such as a plastic or a ceramic. This makes it possible to optimize the production process and production costs and improve the mechanical properties of the sensor housing. At the same time, it is possible to design the coating 114.2 to be very thin, so that the impedance of the ion-selective sensor element 114 can be minimized in the desired manner.

During the production of the sensor, the ceramic substrate 114.1 can be coated with the ion-selective membrane glass either before or after being installed in the housing.

Instead of the ion-selective sensor element 114 shown here in FIG. 2, which is designed as a composite body consisting of a porous ceramic substrate 114.1 and an ion-selective coating 114.2 that is intended to contact a measuring fluid and is applied to the exterior side of the substrate 114.1 and consists of an ion-selective polymer material or a pH-membrane glass, the measuring half-cell 112 can also have a composite body consisting of a porous ceramic substrate and an ion-selective component that fills the pores of the ceramic substrate. To produce such a composite body, the porous ceramic substrate can be saturated with a liquid, ion-selective component comprising an ionophore that solidifies within the pores of the substrate by, for example, polymerization. In so doing, a continuous coating does not necessarily have to be formed on a surface of the substrate as in the embodiment shown in FIG. 2. An ion-selective component of the composite body in the pores of the substrate is enough to provide sufficient ion selectivity of the sensor element 114. Otherwise, the measuring half-cell 112 can be designed in this alternative embodiment as shown in FIG. 2 and described above.

FIG. 3 shows a third exemplary embodiment of a measuring half-cell 212 of a potentiometric sensor. In this case, the measuring cell housing 213 and a substrate 214.1 of an ion-selective composite body are designed as a single piece from a ceramic. The measuring cell housing 213 is formed by a ceramic tube that is sealed at its front-end, intended to be immersed in a measuring liquid, by a disk-shaped wall that simultaneously forms the substrate 214.1 of the ion-selective composite body. The composite body comprises an ion-selective coating 214.2 as the ion-selective component. In the present example, the measuring cell 212 is designed as a pH-measuring half-cell. The ion-selective coating 214.2 is correspondingly formed as a pH-selective coating consisting of a pH membrane glass. The ceramic from which the measuring cell housing 213 and the substrate 214.1 is formed is selected so that its thermal expansion coefficient differs from that of the pH membrane glass by less than 10%. In the measuring cell chamber enclosed by the wall of the measuring cell housing 213 and the side of the substrate 214.1 opposite the coating 214.2, a liquid inner electrolyte 220 is accommodated, which can, for example, be a pH buffer solution. A potential-sensing element 219 is immersed in the inner electrolyte 220 and serves to discharge the half-cell potential.

In the region of the substrate 214.1, the ceramic material is provided with pores that are filled with the inner electrolyte 220 so that the coating 214.2 is in contact at the rear with the inner electrolyte 220. The pores can, for example, be created by a sintering process during the production of the housing 213, 214.1. Alternatively, the pores can be introduced locally in the substrate exclusively by subsequently treating the substrate 214.1. It is also possible to design both the substrate 214.1 and the tubular housing wall 213 from a porous ceramic, wherein the tubular housing is designed with a liquid-impermeable coating, at least on its outside, or is surrounded by a liquid-impermeable casing so that, upon the immersion of the measuring half-cell 212 in a measuring liquid, the measuring liquid does not penetrate through the housing wall 213 into the half-cell chamber.

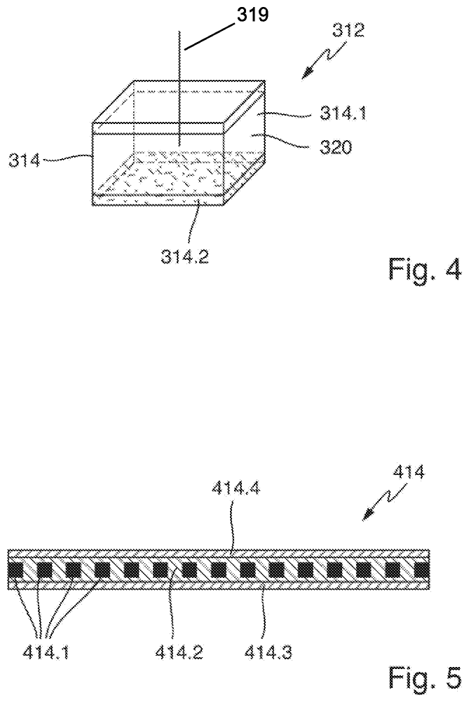

FIG. 4 schematically portrays another exemplary embodiment of a pH-measuring half-cell 312 that is designed very compactly and is therefore suitable for use in a miniaturized potentiometric sensor. The measuring half-cell 312 has a composite body 314 that has a substrate 314.1 consisting of a porous ceramic on which a coating 314.2 consisting of a pH-sensitive membrane glass is applied on a side intended to be in contact with a measuring liquid. The substrate 314.1 can have a thickness within a range of a few millimeters; the coating 314.2 can have a thickness within a range of a few μm. The pores of the substrate 314.1 are filled with a liquid or solidified inner electrolyte 320 in a region adjacent to the coating 314.2 at the rear. A section of a potential-sensing element 319 runs within the substrate 314.1 such that it contacts the inner electrolyte 320 and can discharge a measuring half-cell potential forming at the coating 314.2 in contact with a measuring liquid. The composite body 314 can be affixed within a housing similar to the composite body of the measuring half-cell shown in FIG. 2, such that the inner electrolyte is sealed from the measuring liquid. Alternatively, the surface regions of the substrate 314.1 that are not covered by the coating 314.2 can be covered by a water-impermeable coating.

FIG. 5 schematically portrays an exemplary embodiment 414 that can be used as a sensor element in a potentiometric sensor analogous to the sensor elements in the above-described exemplary embodiments.

The composite body 414 comprises an electrically-conductive, especially metallic, sieve 414.1 that can, for example, be formed from platinum or a Fe—Ni—Co alloy. This is surrounded by a layer 414.2 consisting of a low-impedance glass. A layer 414.3, 414.4, consisting of an ion-selective membrane glass, such as a sodium-selective membrane glass, is applied on both sides of the layer 414.2. The composite body 414 can be used in a measuring half-cell of a potentiometric sensor such that one of the layers 414.3, 414.4 is in contact with the measuring liquid, whereas the opposite layer 414.3, 414.4 is in contact with an inner electrolyte, so that a measuring half-cell potential arises which depends upon the analyte activity in the measuring medium.

In this exemplary embodiment, the high mechanical stability of the composite body 414, as well as the very low impedance of the composite body, are particularly advantageous, since electrons are conducted by the metal in the volume phase.

To produce the composite body 414, the sieve consisting of conductive material can first be immersed in a melt of the low-impedance glass. After the glass solidifies, the substrate formed from the two components can be coated on both sides with the ion-selective membrane glass.

What is claimed is:

1. A potentiometric sensor comprising:
an electrochemical half-cell, including:
a housing;
an inner electrolyte disposed in the housing;
a pickup electrode contacting the inner electrolyte; and
a composite body including a porous ceramic substrate and an ion-selective component, wherein the ion-selective component is disposed on the porous ceramic substrate and/or has penetrated pores of the porous ceramic substrate, wherein the ion-selective component is embodied to contact a liquid measuring medium and to be immersible in the liquid measuring medium,
wherein the ion-selective component is in contact with the inner electrolyte, and
wherein the composite body is clamped or affixed liquid tightly in a wall of the housing.

2. The potentiometric sensor according to claim 1, wherein the composite body is clamped or affixed liquid tightly in the wall of the housing by elastomer seals.

3. The potentiometric sensor according to claim 2,
wherein the housing has a wall that forms and at least partially encloses a half-cell chamber, wherein the housing has an opening at a front end of the housing;
wherein the inner electrolyte is disposed in the half-cell chamber;
wherein the potentiometric sensor includes a first elastomer seal and a second elastomer seal, wherein the composite body is disposed at the front end of the housing such that the sensor element, the first elastomer seal, and the second elastomer seal seal the opening at the front end of the housing.

4. The potentiometric sensor according to claim 3, wherein the ion selective component is disposed on a side of the porous ceramic substrate facing away from the half-cell chamber.

5. The potentiometric sensor according to claim 4,
wherein the housing includes a first tubular part and a second tubular part, wherein the first tubular part includes threads disposed on an outer circumference of the first tubular part and the second tubular part includes threads disposed on an inner circumference of the second tubular part in such a way that the second tubular part can be screwed onto the first tubular part, and
wherein the composite body is positioned between the first and second elastomer seals and is clamped liquid tightly to the housing, when the second tubular part is screwed onto the first tubular part.

6. The potentiometric sensor according to claim 1, wherein the porous ceramic includes zirconium dioxide ceramics, magnesium-stabilized zirconium dioxide ceramics, or yttrium-stabilized zirconium dioxide ceramics.

7. The potentiometric sensor according to claim 1, wherein the ion-selective component includes an ion-selective polymer or a pH membrane glass.

8. The potentiometric sensor according to claim 7, wherein the ion-selective component is a coating on the porous ceramic substrate.

9. The potentiometric sensor according to claim 7, wherein the thermal expansion coefficient of the porous ceramic is adjusted to that of the ion selective component.

10. The potentiometric sensor according to claim 1, further comprising:
a reference half-cell; and
a measuring circuit,
wherein the measuring circuit is designed to detect a difference in potential between the electrochemical half-cell and the reference half-cell and to output a measuring signal representing the difference in potential.

11. The potentiometric sensor according to claim 1, wherein the ion selective component is in contact with the inner electrolyte via pores of the porous ceramic substrate.

12. A potentiometric sensor comprising:
an electrochemical half-cell, including:
a housing having a wall that forms and at least partially encloses a half-cell chamber, wherein the housing has an opening at a front end of the housing;
a composite body including a porous ceramic substrate and an ion-selective component, wherein the ion-selective component is disposed on a first side of the porous ceramic substrate and/or has penetrated pores of the porous ceramic substrate, wherein the ion-selective component is embodied to contact a liquid measuring medium and to be immersible in the liquid measuring medium;
a first elastomer seal and a second elastomer seal, wherein the composite body is disposed at the front end of the housing such that the composite body, the first elastomer seal, and the second elastomer seal seal the opening at the front end of the housing, and wherein the ion-selective component faces away from the half-cell chamber;
an inner electrolyte disposed in the half-cell chamber; and
a pickup electrode contacting the inner electrolyte in the half-cell chamber.

13. The potentiometric sensor according to claim 12,
wherein the housing includes a first tubular part and a second tubular part, wherein an inner circumference of the second tubular part corresponds to an outer circumference of the first tubular part,
wherein the first tubular part includes threads disposed on the outer circumferences and the second tubular part includes threads disposed on the inner circumference,
wherein the threads of the first tubular part and of the second tubular part are complementary and enable the second tubular part to be screwed onto the first tubular part, and
wherein the second tubular part is embodied to clamp the first elastomer seal, the composite body, and the second elastomer seal to the first tubular part and thereby close and seal the half-cell chamber.

14. The potentiometric sensor according to claim 12,
wherein the porous ceramic is zirconium dioxide, magnesium-stabilized zirconium dioxide, or yttrium-stabilized zirconium dioxide.

15. The potentiometric sensor according to claim 12,
wherein the ion-selective component includes an ion-selective polymer or a pH membrane glass.

16. The potentiometric sensor according to claim 15, wherein the ion-selective component is a coating on the porous ceramic substrate.

17. A potentiometric sensor, comprising:
an electrochemical half-cell, the electrochemical half-cell including:
a housing;
an inner electrolyte disposed in the housing;
a pickup electrode contacting the inner electrolyte; and
a sensor element including a porous ceramic substrate comprising a solid body and an ion-selective component, wherein the ion-selective component is disposed on the porous ceramic substrate and/or has penetrated pores of the porous ceramic substrate, wherein the ion-selective component is embodied to contact a liquid measuring medium and to be immersible in the liquid measuring medium,
wherein the ion-selective component is in contact with the inner electrolyte, and
wherein the sensor element is affixed liquid-tightly in a wall of the housing by elastomer seals, and wherein the sensor element is not materially bonded to the housing wall.
